(19) United States
(12) Patent Application Publication
(10) Pub. No.: US 2025/0242670 A1
(43) Pub. Date: Jul. 31, 2025

(54) MOTOR VEHICLE WINDOW AND MOTOR VEHICLE COMPRISING SUCH A MOTOR VEHICLE WINDOW

(71) Applicant: Webasto SE, Stockdorf (DE)

(72) Inventors: Michael STEIGTHALER, Stockdorf (DE); Milan MATOK, Stockdorf (DE); Maximilian FISCHER, Stockdorf (DE)

(21) Appl. No.: 18/986,076

(22) Filed: Dec. 18, 2024

(30) Foreign Application Priority Data
Jan. 10, 2024 (DE) 10 2024 100 675.7

(51) Int. Cl. B60J 3/04; B60Q 3/208

(52) U.S. Cl. CPC B60J 3/04; B60Q 3/208

(57) ABSTRACT

A motor vehicle window having a composite structure having at least two window bodies and a light source. The motor vehicle window has an opaque frame disposed on top of the first window body in such a manner that the opaque frame encloses the second window body, the light source being fixed to a bottom side of the first window body.

### CROSS-REFERENCE TO RELATED APPLICATION

This application claims the benefit of German Application No. 10 2024 100 675.7, filed Jan. 10, 2024, which is incorporated herein by reference in its entirety.

### TECHNICAL FIELD

A motor vehicle window, in particular for a passenger car. Furthermore, a motor vehicle having such a motor vehicle window.

### BACKGROUND

Generic motor vehicle windows and motor vehicles comprising such motor vehicle windows are known from the state of the art in various embodiments.

The generic motor vehicle windows typically comprise a composite structure having at least two window bodies disposed on top of the other and being in flat contact with each other. The window bodies are transparent.

In order to cover elements that are not supposed to be visible from a motor vehicle interior and/or from a motor vehicle exterior, it is known from the state of the art for one of the window bodies to be provided with black print.

Furthermore, it is known from the state of the art for the elements of the motor vehicle that are to be hidden to be covered by means of cover elements. Aluminum bands fixed to the motor vehicle window are used for this purpose, for example.

Attaching cover elements to motor vehicle windows requires additional steps during the production of motor vehicle windows, which in turn increases production time and cost. Moreover, if components are covered by means of cover elements, there is a risk that the cover elements come loose unintentionally.

### SUMMARY

The object of the present invention is to provide a motor vehicle window by means of which components of a motor vehicle that are not supposed to be visible from a motor vehicle exterior and/or from a motor vehicle interior can be covered. Furthermore, the object of the present invention is to provide a motor vehicle comprising such a motor vehicle window.

According to the invention, this object is attained by the motor vehicle window having the features of claim 1 and by the motor vehicle having the features of claim 11.

Advantageous embodiments of the invention are the subject matter of the dependent claims.

Any and all combinations of the features disclosed in the description, the claims and/or the drawing fall within the scope of the invention. In particular, it is understood that linguistic rephrasing and/or an analogous replacement of respective terms within the scope of common linguistic practice, in particular the use of synonyms supported by generally recognized linguistic literature, are included in the content of the present disclosure without being explicitly mentioned in their respective formulation.

According to the invention, a motor vehicle window is therefore provided, in particular for a passenger car. The motor vehicle window comprises a composite structure having at least two window bodies and an opaque, i.e., non-transparent, frame. The opaque frame is disposed on the first window body in such a manner that it encloses the second window body at least partially, in particular completely. So the opaque frame preferably directly adjoins the second window body circumferentially.

Accordingly, the core idea of the invention is to provide a composite structure having at least two window bodies, the second window body being disposed on top of the first window body and being laterally surrounded by an opaque frame.

The provision of the opaque frame on the first window body thus allows for a simple way of concealing components that are fixed to the motor vehicle window and that are not supposed to be visible from the motor vehicle exterior.

The opaque frame is part of the composite structure, for example.

In a preferred embodiment of the motor vehicle window according to the invention, the first window body is an inner window body, i.e., a window body that faces the motor vehicle interior.

The second window body can be disposed on a side of the first window body facing the motor vehicle exterior.

For example, the second window body lies flat on the first window body, in particular directly or via a connecting layer.

The second window body is smaller than the first window body, for example. The second window body can have a smaller surface area than the first window body.

In an exemplary embodiment of the motor vehicle window according to the invention, the geometry of the bottom side of the second window body together with the opaque frame corresponds to a geometry of the top side of the first window body. The opaque frame together with the second window body thus has the same dimension in the transverse direction as the first window body.

In a preferred embodiment, the motor vehicle window according to the invention comprises three window bodies.

For example, the first window body is an inner window body, the second window body is a shading body, and the third window body is an outer window body facing the motor vehicle exterior.

The shading body can be disposed between the first window body and the third window body.

A geometry of the bottom side of the third window body corresponds to the geometry of the top side of the second window body together with the opaque frame, for example.

In an exemplary embodiment of the motor vehicle window according to the invention, the shading body comprises or is formed by a polymer-dispersed liquid crystal layer.

The polymer-dispersed liquid crystal layer is disposed between two plastic films, for example.

The plastic films can also be part of the second window body or can connect the second window body to the first window body and the third window body, respectively.

The polymer-dispersed liquid crystal layer can have a polymer-dispersed liquid crystal material (PDLC material) that is disposed between electrically conductive layers.

The electrically conductive layers are disposed between two plastic films, for example.

At least one of the plastic films is a hot-melt adhesive film, which can be made of polyvinyl butyral (PVB), for example.

Furthermore, a polyethylene terephthalate film (PET film) can be provided as a plastic film.

The opaque frame is also disposed between the two plastic films, for example. So only the polymer-dispersed liquid crystal layer is surrounded by the opaque frame, for example, while the polymer-dispersed liquid crystal layer and the opaque frame circumferentially surrounding the polymer-dispersed liquid crystal layer are covered, in particular across their entire surface, by the plastic films at a top side and at a bottom side.

In an exemplary embodiment of the motor vehicle window according to the invention, the first window body is a diffusing lens or a diffuser, that is, an optical component suitable for scattering light.

The first window body can comprise light-scattering elements in the window body.

In an exemplary embodiment of the motor vehicle window according to the invention, light-scattering elements are disposed on the first window body, for example as full-surface or partial print.

In a preferred embodiment of the motor vehicle window according to the invention, the first window body comprises optical elements, in particular a lens structure, a grid and/or a hologram for coupling in light and/or for coupling out light.

The hologram is a volume hologram, for example.

The opaque frame has a closed, frame-shaped profile, for example.

It is also conceivable for the opaque frame to circumferentially surround only part of the second window body, i.e., for example, to be disposed on one side of the second window body or on two opposite sides of the second window body.

In a preferred embodiment, the motor vehicle window according to the invention comprises at least one light source.

The light source can be disposed in such a manner that light from the light source can be coupled into the first window body.

The light source is fixed to the bottom side of the first window body, which faces the motor vehicle interior when the motor vehicle window is disposed on a motor vehicle in accordance with its intended use.

In a preferred embodiment of the motor vehicle window according to the invention, the light source is disposed on the first window body in such a manner that it is flush with the opaque frame in a first direction.

For example, the light source is completely covered by the opaque frame in the first direction.

For example, the first direction extends from the motor vehicle interior to the motor vehicle exterior, i.e., orthogonally to a transverse direction of the motor vehicle window.

In an exemplary embodiment of the motor vehicle window according to the invention, the opaque frame has the same thickness as the second window body.

The opaque frame can have the same thickness as the polymer-dispersed liquid crystal layer of the second window body.

In an exemplary embodiment of the motor vehicle window according to the invention, an outer edge of the opaque frame is aligned with an outer edge of the first window body, of the third window body and/or of the plastic films. So the motor vehicle window has flat lateral surfaces.

In a preferred embodiment of the motor vehicle window according to the invention, a light transmission level (tL) of the opaque frame is at least approximately 0, in particular 0.

The opaque frame has a high light absorption level, for example.

The opaque frame can be cloudy, scattering and/or light-reflecting.

For example, a concealing element is disposed on the bottom side of the second window body, i.e., on the side of the second window body facing the first window body.

For example, the concealing element is a print, in particular black print, and/or a coating.

The concealing element can be frame-shaped.

For example, a dimension of the concealing element in the transverse direction and/or in the longitudinal direction of the vehicle window, in particular in the direction of a center of the vehicle window, is at least partially larger than a dimension of the opaque frame.

The opaque frame can be completely covered by the concealing element when viewed from the motor vehicle exterior.

The window bodies are each plate-shaped, for example. So the window bodies each have the shape of a rectangle or a square with a low height and/or curvature, for example.

The corners of the rectangle or square are rounded, for example.

In a preferred embodiment of the motor vehicle window according to the invention, the motor vehicle window is a motor vehicle roof element.

The motor vehicle window is a panoramic roof element or a sunroof element, for example.

Furthermore, the invention relates to a motor vehicle comprising a motor vehicle window as described above.

The motor vehicle window is part of a motor vehicle roof, in particular of a panoramic roof assembly or a sliding roof assembly.

Further advantages and advantageous configurations of the subject matter of the invention can be found in the description, the drawing and the claims.

### BRIEF DESCRIPTION OF DRAWINGS

An exemplary embodiment of a motor vehicle window according to the invention is shown in a schematically simplified manner in the drawing and is explained in more detail in the following description.

FIG. 1 is a top side view of a motor vehicle window according to the invention; and

FIG. 2 is a section view along line II-II in FIG. 1.

### DETAILED DESCRIPTION

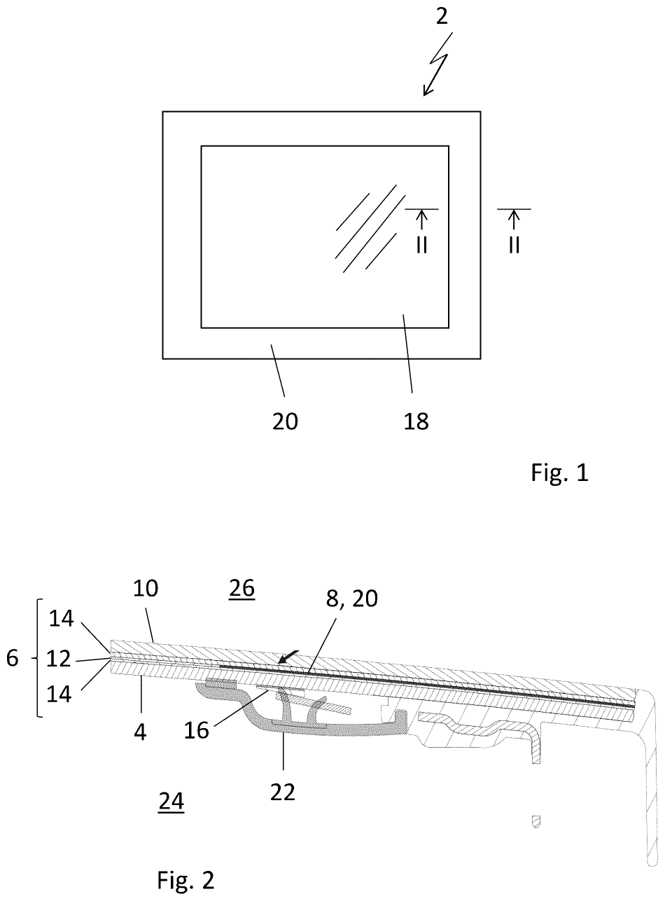

FIGS. 1 and 2 show a motor vehicle window 2 according to the invention.

As can be seen from FIG. 1, the motor vehicle window 2 comprises a transparent inner area 18, which forms a viewing area, and an edge area 20 or frame area. The edge area 20 circumferentially surrounds the inner area 18 and is opaque, i.e., not transparent, in particular cloudy. The edge area 20 is defined by the geometry of an opaque frame 8 and serves to conceal elements that are not supposed be visible or should be covered when viewed from a motor vehicle exterior 26.

The motor vehicle window 2 has a composite structure comprising a first window body 4, a second window body 6, a third window body 10, the opaque frame 8, and two plastic films 14 (see FIG. 2).

The first window body 4 is an inner window body, i.e., the window body of the motor vehicle window 2, which faces a motor vehicle interior 24. A first one of the plastic films 14 is provided on the first window body 4. The second window body 6 and the opaque frame 8 are disposed on the first plastic films 14. The second window body 6 is completely surrounded by the opaque frame 8 at the circumference. The opaque frame 8, together with the second window body 6, covers the entire top side of the first plastic film 14, which in turn completely covers the entire top side of the first window body 4.

The first window body 4, the first plastic films 14 and the second window body 6 together with the opaque frame 8 thus have the same dimensions in the transverse direction or the same profile in a plan view. The sum of the surface area of the bottom side of the opaque frame and the bottom side of the second window body 6 thus corresponds to the area of the top side of the first window body 4.

It is also conceivable (in deviation from the illustrated embodiment) to provide an opaque frame on only one side or on individual sides of the second window body 6.

The second plastic film 14, which connects the second window body 6 and the opaque frame 8 to the third window body 10, is disposed on a top side of the second window body 6 and of the opaque frame 8. So the third window body 10 forms a top side of the motor vehicle window 2, which faces the motor vehicle exterior 26.

The dimension of the third window body 10 in the transverse direction corresponds to the dimension of the plastic films 14, the dimension of the second window body 6 together with the opaque frame 8, and the dimension of the first window body 4.

In deviation from the embodiment shown in the figures, it is also conceivable for the second window body 6 and/or the opaque frame 8 to be disposed directly on the first window body 4 or the third window body 10, i.e., for no plastic films 14 to be provided.

The second window body 6 is formed by a polymer-dispersed liquid crystal layer 12 and thus serves as a shading arrangement.

The plastic films 14 have the same dimensions or the same geometry in the transverse direction as the first window body 4 and the third window body 10.

The first window body 4 is a diffusing lens. A light source 16 is disposed on a bottom side of the first window body 4, which faces the motor vehicle interior 24. Light from the light source 16 can be coupled into the first window body 4.

The light source 16 is disposed on the first window body 4 in such a manner that the light source 16 is completely covered in a first direction, namely in the direction from the motor vehicle interior 24 to the motor vehicle exterior 26. The light source 16 is thus not visible from the motor vehicle exterior 26.

The motor vehicle window 2 is a motor vehicle roof element, in particular a panoramic roof.

### REFERENCE SIGNS

2 motor vehicle window
4 first window body
6 second window body
8 opaque frame
10 third window body
12 polymer-dispersed liquid crystal layer
14 plastic film
16 light source
18 inner area
20 edge area
22 cover element
24 motor vehicle interior
26 motor vehicle exterior

1. A motor vehicle window comprising:
a composite structure having at least two window bodies and a light source,
wherein an opaque frame is disposed on top of the first window body in such a manner that the opaque frame encloses the second window body,
the light source being fixed to a bottom side of the first window body.

2. The motor vehicle window according to claim 1, the motor vehicle window having three window bodies, the first window body being an inner window body, the second window body being a shading body, the third window body being an outer window body, and the second window body being disposed between the first window body and the third window body.

3. The motor vehicle window according to claim 1, wherein the second window body comprises or is formed by a polymer-dispersed liquid crystal layer.

4. The motor vehicle window according to claim 3, wherein the polymer-dispersed liquid crystal layer and/or the opaque frame are/is disposed between two plastic films.

5. The motor vehicle window according to claim 1, wherein the first window body is a diffusing lens.

6. The motor vehicle window according to claim 1, wherein the light source is disposed in such a manner that light of the light source can be coupled into the first window body.

7. The motor vehicle window according to claim 1, wherein the light source is disposed on the first window body in such a manner that the light source is flush with the opaque frame in a first direction fully covered by the opaque frame.

8. The motor vehicle window according to claim 1, wherein the opaque frame has the same thickness as the second window body and/or the polymer-dispersed liquid crystal layer.

9. The motor vehicle window according to claim 1, wherein an outer edge of the opaque frame is flush with an outer edge of the first window body and/or of the third window body.

10. The motor vehicle window according to claim 1, wherein the motor vehicle window is a motor vehicle roof element.

11. A motor vehicle comprising a motor vehicle window according to claim 1.
